(19) United States
(12) Patent Application Publication
(10) Pub. No.: US 2014/0327520 A1
(43) Pub. Date: Nov. 6, 2014

(54) RADIO IDENTIFICATION ARRANGEMENT AND METHOD FOR INDICATING THE POSITION OF A PHYSICAL OBJECT

(71) Applicant: INFINEON TECHNOLOGIES AG, Neubiberg (DE)

(72) Inventors: Bala Nagendra Raja Munjuluri, Bangalore (IN); Konanur Ramachandra Satyamurthy, Bangalore (IN)

(73) Assignee: Infineon Technologies AG, Neubiberg (DE)

(21) Appl. No.: 13/875,382

(22) Filed: May 2, 2013

(51) Int. Cl. G06K 7/10

(52) U.S. Cl. CPC G06K 7/10366
USPC 340/8.1

(57) ABSTRACT

According to one embodiment, a radio identification arrangement is described comprising a signal emitter and a controller configured to detect whether the radio identification arrangement has received a radio signal which specifies an identification of the radio identification arrangement from a radio identification device or the radio identification arrangement has received a first indication signal from another radio identification arrangement and configured to control the signal emitter to emit a second indication signal if the radio identification arrangement has received a radio signal specifying the identification from a radio identification device or the radio identification arrangement has received a first indication signal from another radio identification arrangement.

### TECHNICAL FIELD

The present disclosure relates to radio identification arrangements and methods for indicating the position of a physical object.

### BACKGROUND

In storages for a large number of objects, such as warehouses, archives or libraries, it is typically desired that a user is able to quickly find certain objects. Systems for helping a user to quickly find an object may include localization of the object by means of an RFID tag attached to the object and visual and/or audible indications to the user. However, a visual indication, for example, may be obstructed in case that the object lies in a row arranged behind another row of objects and in case of an audible indication the user may still need to spend some time until being able to find out where the indication is coming from.

Accordingly, enhanced methods and systems to help a user searching for an object among a large number of objects are desirable.

### SUMMARY

According to one embodiment, a radio identification arrangement is provided including a signal emitter and a controller configured to detect whether the radio identification arrangement has received a radio signal which specifies an identification of the radio identification arrangement from a radio identification device or the radio identification arrangement has received a first indication signal from another radio identification arrangement and configured to control the signal emitter to emit a second indication signal if the radio identification arrangement has received a radio signal specifying the identification from a radio identification device or the radio identification arrangement has received a first indication signal from another radio identification arrangement.

Further, a method for indicating the position of a physical object according to the radio identification arrangement described above is provided.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows an example inventory.

FIG. 2 shows a communication arrangement.

FIG. 3 shows a radio identification arrangement according to an embodiment.

FIG. 4 shows a flow diagram according to an embodiment.

FIG. 5 shows a communication arrangement according to an embodiment.

FIG. 6 shows an inventory box according to an embodiment.

### DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

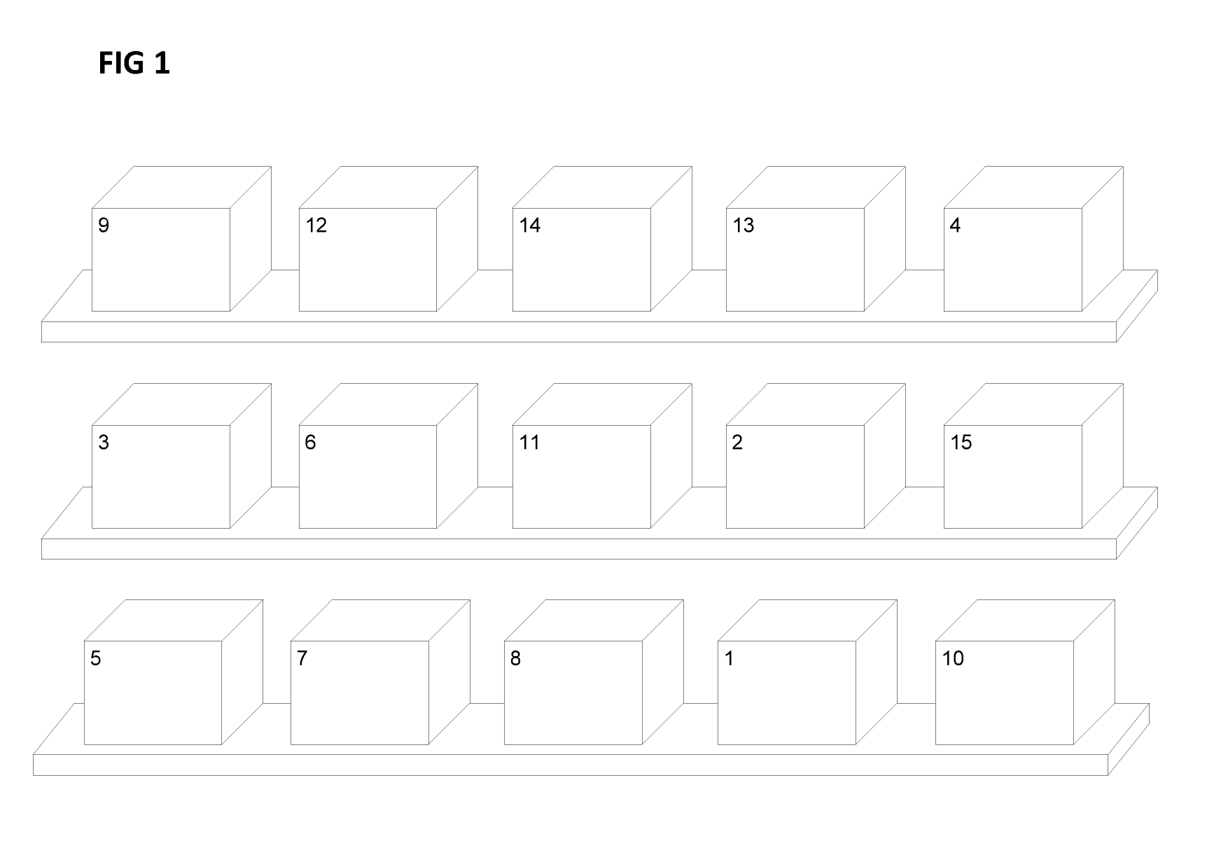

FIG. 1 shows an example inventory.

The inventory includes 15 objects (uniquely numbered from 1 to 15), in this example boxes, arranged in three rows and five columns

In this example, the boxes are not ordered. Accordingly, to locate a box, a user needs to scan for the correct box through all rows and column which involves considerable effort.

To simplify the searching process, the boxes could be ordered, e.g. by starting with box number one at the top left and proceeding from left to right and top to bottom in the order of the numbering of the boxes until box 15 is placed at the bottom right. The user could then use a simple mod operation to determine the row in which a box that he searches for is placed. However, this approach leads to the additional initial effort to put the boxes in order and to maintain the order when boxes are added or removed. Further, this approach gets more complex when the boxes are not numbered continuously. Such approaches of sorting the objects and placing them in appropriate (e.g. incrementally numbered) areas, such as the rows in the above example, can be seen as process oriented approaches.

Another class of approaches includes technology oriented approaches.

In such an approach, a bar code or an RFID (radio-frequency identification) tag is for example attached to each object in the inventory. Inventory management software may then be used to keep a mapping of an object (or tag) ID and the location of the object such that the object may be quickly found.

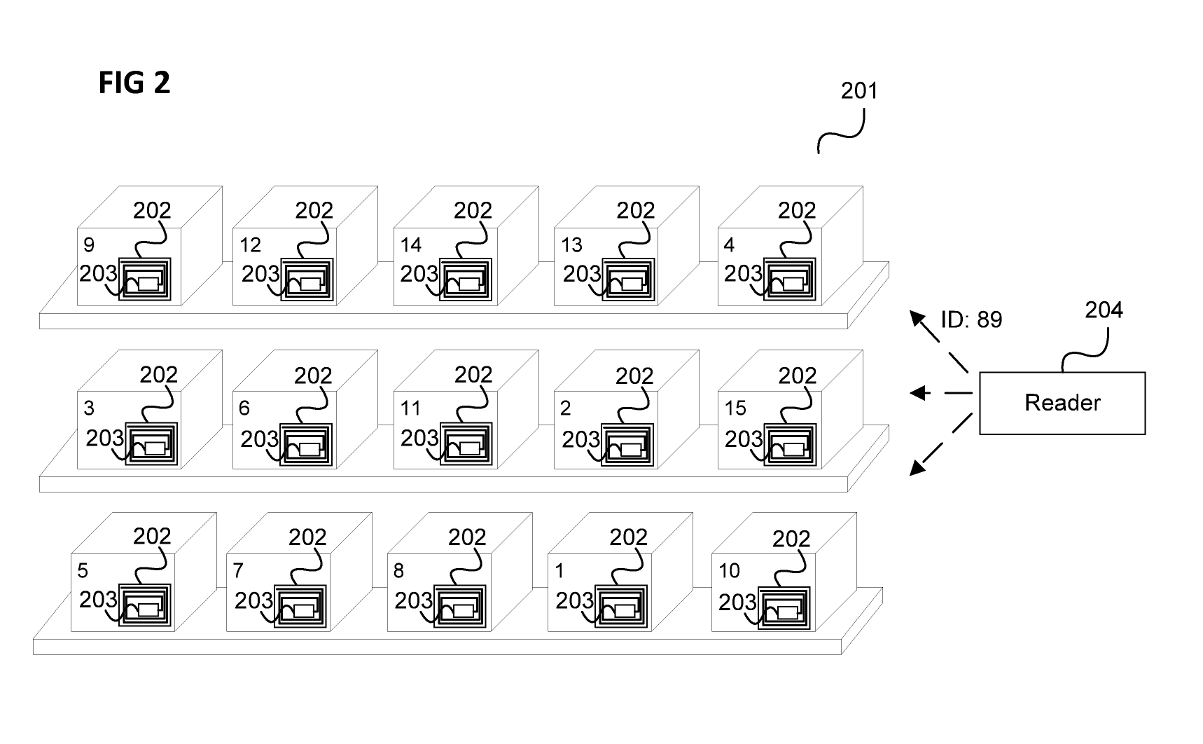

To further enhance finding an object, a visual indication, such as an LED (light emitting diode) may be embedded in the RFID tag attached to an object. This is illustrated in FIG. 2.

FIG. 2 shows a communication arrangement 200.

The communication arrangement includes an inventory 201 including, as in the example of FIG. 1, 15 boxes numbered from 1 to 15. Each box is provided with an RFID tag 202 which has an embedded LED 203.

Each RFID tag 202 is assigned with a unique ID. For example, box number 13 has the RFID tag with the ID 89.

The communication arrangement 200 further includes an RFID reader 204 which may be used by a user to quickly find objects. For example, when the user searches for box 13 he may input its RFID tag ID, i.e. the ID 89, into the reader 204. The reader 204 sends out a request for this ID and the RFID tag of box 13 in response turns its LED 204 on such that the user can see which one is the right box.

This approach may work well in an inventory such as a library where the aim is storage and display and the objects are therefore arranged next to each other. However, in an inventory such as a warehouse, where the aim is only storage, objects may be placed one behind the other to save space such that LEDs may be obstructed.

According to one embodiment, a radio identification arrangement and a method are provided that may be used for locating a desired individual object in a set of objects (or a heap of objects) in a fast and user friendly manner. This may for example be applied in inventory/warehouse/archive management.

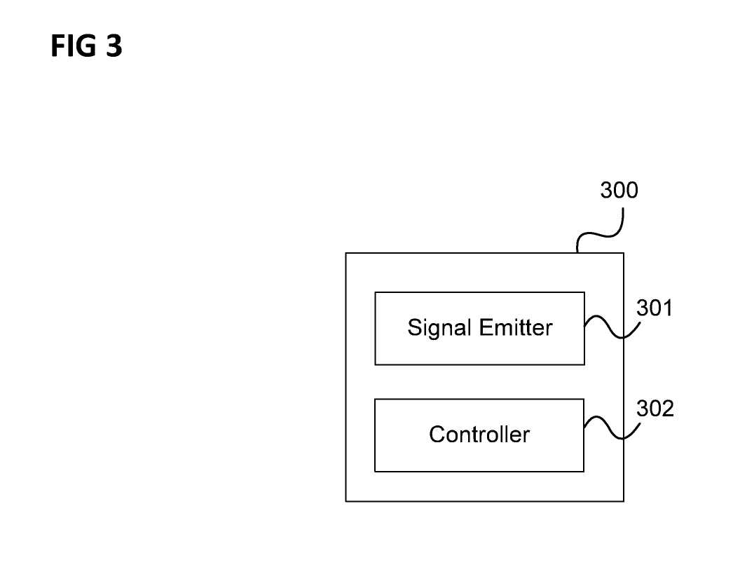

FIG. 3 shows a radio identification arrangement 300 according to an embodiment.

The radio identification arrangement 300 includes a signal emitter 301 and a controller 302.

The controller 302 is configured to detect whether the radio identification arrangement has received a radio signal which specifies an identification of the radio identification arrangement from a radio identification device or the radio identification arrangement has received a first indication signal from another radio identification arrangement and configured to control the signal emitter to emit a second indication signal if the radio identification arrangement has received a radio signal specifying the identification from a radio identification device or the radio identification arrangement has received a first indication signal from another radio identification arrangement.

According to one embodiment, in other words, a radio identification arrangement (e.g. an RFID tag arrangement) emits a signal when it has received a signal with its identification (i.e. when it has been addressed itself) or when it receives a signal from another radio identification arrangement, e.g. indicating that the other radio identification arrangement or an even further radio identification arrangement has been addressed. For example, the other radio identification arrangement is a radio identification arrangement arranged behind the radio identification arrangement and the further radio identification arrangement is a radio identification arrangement in a row that is arranged even further behind the radio identification arrangement. For example, if the radio identification arrangement is arranged on an object between an object that has been addressed and an object in a front row of an inventory, the radio identification arrangements detects the second indication signal to keep the signaling process ongoing.

The radio identification arrangement may for example include a circuit indicating an identification of the radio identification arrangement.

The circuit is for example a memory.

According to one embodiment, at least one of the first indication signal and the second indication signal is a signal indicating the location of a physical object.

According to one embodiment, at least one of the first indication signal and the second indication signal is a visual signal.

At least one of the first indication signal and the second indication signal may also be a radio signal.

The signal emitter is for example a light source e.g. an LED.

According to one embodiment, the second indication signal has a first form if the radio identification arrangement has received a radio signal which specifies an identification of the radio identification arrangement has been emitted by a radio identification device and has a second form if the radio identification arrangement has received a first indication signal from another radio identification arrangement.

For example, the second indication signal is a visual signal and the first form is visually distinguishable from the second form. For example, the rate of blinking of the second indication signal may be different in the first form and the second form or in one of the forms, it may not blink at all but may be constantly glowing.

The radio identification arrangement may include a detector configured to detect whether the radio identification arrangement has received the first indication signal from the other radio identification arrangement.

According to one embodiment, the first indication signal is a light signal and the receiver is a photosensitive element configured to detect the first indication signal.

The radio identification arrangement may for example include an RFID tag having the identification of the radio identification arrangement.

A physical object may for example include the radio identification arrangement. The physical object for example includes a first side and a second side, wherein the signal emitter is arranged at the front side and a detector configured to detect whether the other radio identification arrangement has emitted the first indication signal is arranged at the back side.

The first side is for example a front side of the object and the second side is a back side of the object opposite to the front side.

The first side and the second side are for example adjacent sides.

The components of the radio identification arrangement (e.g. the controller) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor. A “circuit” may also be a processor executing software, e.g. any kind of computer program. Any other kind of implementation of the respective functions which will be described in more detail below may also be understood as a “circuit”.

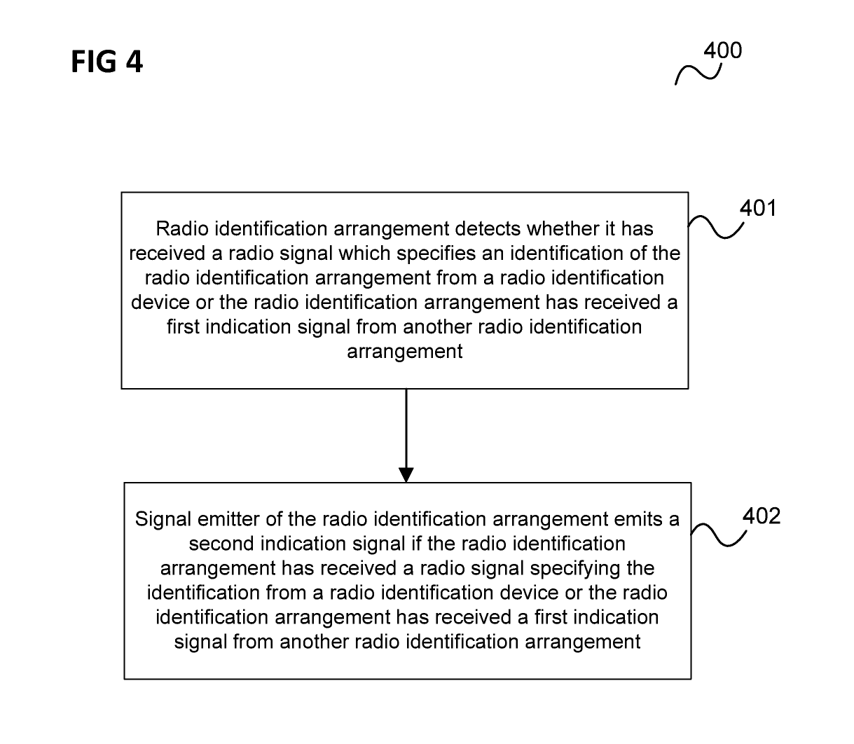

The radio identification arrangement for example carries out a method as illustrated in FIG. 4.

FIG. 4 shows a flow diagram 400 according to an embodiment.

The flow diagram 400 illustrates a method for indicating the position of a physical object.

In 401, a radio identification arrangement detects whether it has received a radio signal which specifies an identification of the radio identification arrangement from a radio identification device or the radio identification arrangement has received a first indication signal from another radio identification arrangement.

In 402, a signal emitter of the radio identification arrangement is controlled to emit a second indication signal if the radio identification arrangement has received a radio signal specifying the identification from a radio identification device or the radio identification arrangement has received a first indication signal from another radio identification arrangement.

It should be noted that embodiments described in context with the radio identification arrangement are analogously valid for the method illustrated in FIG. 4 and vice versa.

In the following, embodiments are described in more detail.

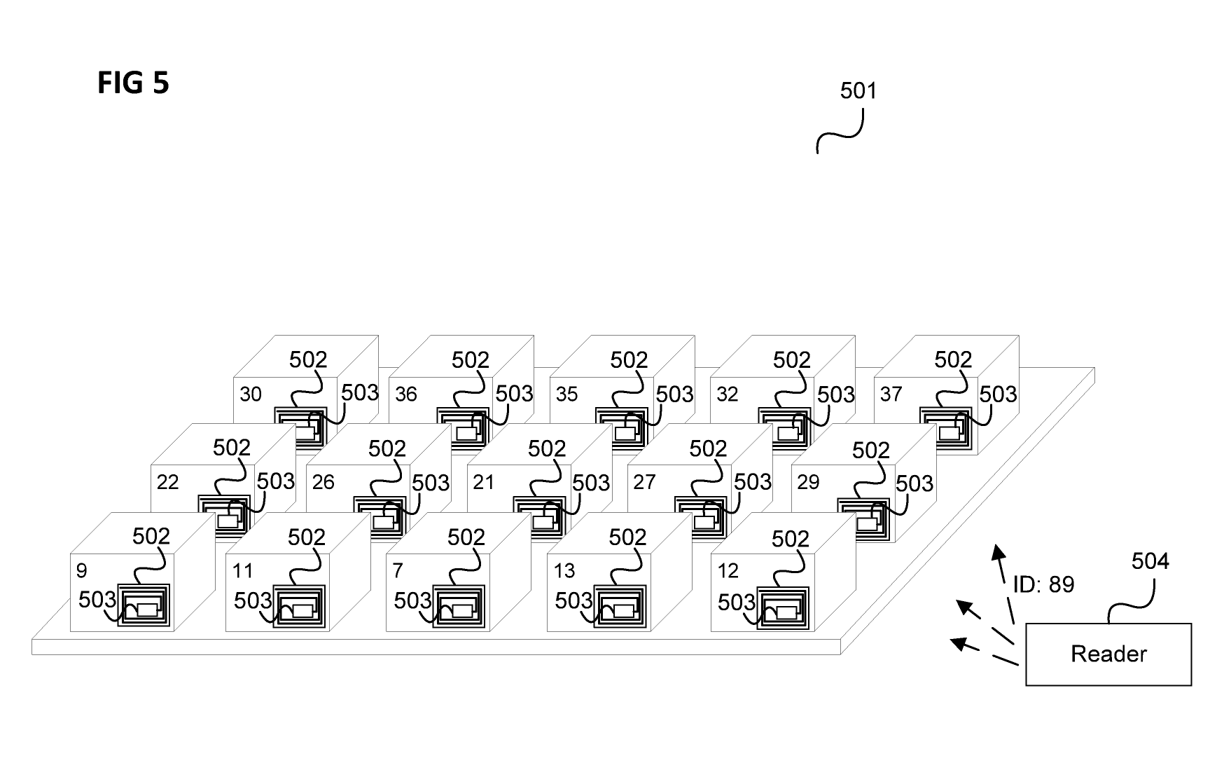

FIG. 5 shows a communication arrangement 500.

The communication arrangement 500 includes an inventory 501 of 15 boxes which are non-continuously numbered between 7 and 37. As described with reference to FIG. 2, each box is provided with an RFID tag 502 wherein each RFID tag 502 includes and LED 503. In this example, the boxes are arranged in rows that lie behind each other. For example, box 29 is behind box 12 and box 37 is behind box 29. Thus, if a reader 504 sends a request addressed to the RFID tag of box 37 which is assumed to have the identification 89, and the LED of box 37 glows a user may not be able to see it.

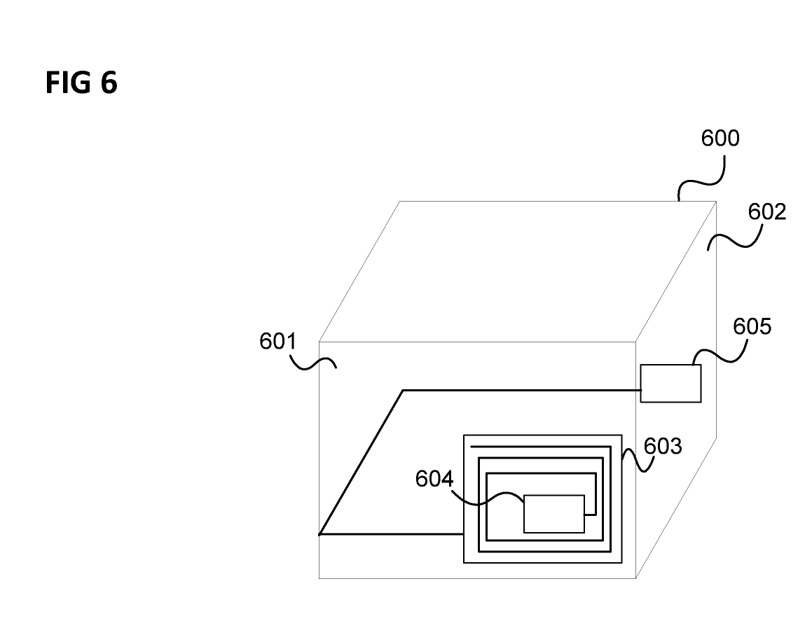

Therefore, according to one embodiment, the boxes are provided with a photosensitive component such as a photo cell or a photo transistor. This is illustrated in FIG. 6.

FIG. 6 shows an inventory box 600 according to an embodiment.

The inventory box 600 for example corresponds to one of the boxes of the inventory 501.

At a front side 601 of the box, an RFID tag 603 including an LED 604 is provided. At a back side 602 of the box, a photosensitive component 605 is provided which is coupled to the RFID tag 603.

The photosensitive component 605 is for example sensitive to a particular wavelength of light e.g. to the wavelength of the LED 604, e.g. in case all boxes of the inventory 501 are provided with the same LEDs. The photosensitive component 605 generates a signal (e.g. generates a voltage by turning on) when it receives light of this wavelength. This signal is supplied to the RFID tag 603.

The RFID tag 603, the LED 604 and the photosensitive component 605 can be realized on silicon. Depending on the size of the object (in this example the box 600), the shape of the object and the inventory this may be a single silicon chip. Alternatively, the RFID tag 603, the LED 604 and the photosensitive component 605 could be individual components.

In this example, the RFID tag 603 has two modes of operation. The first mode is when the RFID tag 603 receives a signal from the reader 504 that is addressed to the RFID tag 603, i.e. specifies the RFID tag's identification. In response to such a message, the RFID tag activates the LED 604, e.g. to glow. The second mode is when the photosensitive component 605 receives a light signal from an LED of another box. In response to this, the RFID tag also activates the LED 604, e.g. to blink to make it distinguishable from the activation of the first mode. The blinking then indicates that light has been received from another box and a user knows that somewhere behind this box, the box which is to be located (and whose LED glows) is located.

In the example above, when the reader 504 sends a request addressed to the RFID tag of box 37 which is assumed to have the identification 89, the LED of box 37 starts to glow in response to the request. The photosensitive component of box 29 receives the light and is for example turned on. In response, the LED of box 29 blinks. Similarly, in response to the reception of the light from box 29, the LED of box 12 blinks. A user can see box 12 blinking, can remove it, can see box 29 blinking, can remove it and finally can see box 37 glowing and will thus know that this is the box he has searched for.

The blinking of the LEDs may be different depending on whether the photosensitive component has received light from a glowing LED or a blinking LED. For example, the LED may blink faster when light from a glowing LED has been received and slower when light from a blinking LED has been received. For example, the rate of blinking may depend on the distance to the box for which the user searched, i.e. the further a box is from the searched box, the slower its LED blinks.

For example, it is assumed that here are six boxes with Box 1 in the front row and Box 6 in the last row according to following order: Box 1, Box 2, Box 3, Box 4, Box 5, Box 6 and the user searches for Box 4, i.e. Box 4 has been addressed. In such a case, for example:
LED on Box 4: On Continuously.
LED on Box 3: On for X seconds. Off for X seconds.
LED on Box 2: On for 2X seconds. Off for 2X seconds.
LED on Box 1: On for 3X seconds. Off for 3X seconds.

The LED may also glow in different colors depending on whether it is activated in the first mode of operation or the second mode of operation or depending on whether the photosensitive component has received light from a glowing LED or a blinking LED.

It should be noted that the boxes should be orderly placed such that the photosensitive component of a box can receive the light from a the LED of the box behind the box.

Instead of the boxes communicating via light, a box that is behind another box (i.e. the respective RFID tag) may also pass a sort of token or information to the box before it using radio communication. For this, a protocol may be provided that allows the RFID tags to communicate and for example allows a box (i.e. the RFID tag of a box) to determine that it is behind another box. Further, a functionality that allows an RFID tag to determine the proximity to another RFID tag may be provided for this. This may for example be based on triangulation based on distances determined from diminishing field strengths.

Further, instead of light signals, sound signals may be used.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

What is claimed is:

1. A radio identification arrangement comprising
a signal emitter; and
a controller configured to detect whether the radio identification arrangement has received a radio signal which specifies an identification of the radio identification arrangement from a radio identification device or the radio identification arrangement has received a first indication signal from another radio identification arrangement and configured to control the signal emitter to emit a second indication signal if the radio identification arrangement has received a radio signal specifying the identification from a radio identification device or the radio identification arrangement has received a first indication signal from another radio identification arrangement.

2. The radio identification arrangement of claim 1, further comprising a circuit indicating an identification of the radio identification arrangement.

3. The radio identification arrangement of claim 2, wherein the circuit is a memory.

4. The radio identification arrangement of claim 1, wherein at least one of the first indication signal and the second indication signal is a signal indicating the location of a physical object.

5. The radio identification arrangement of claim 1, wherein at least one of the first indication signal and the second indication signal is a visual signal.

6. The radio identification arrangement of claim 1, wherein at least one of the first indication signal and the second indication signal is a radio signal.

7. The radio identification arrangement of claim 1, wherein the signal emitter is a light source.

8. The radio identification arrangement of claim 1, wherein the signal emitter is an LED.

9. The radio identification arrangement of claim 1, wherein the second indication signal has a first form if the radio identification arrangement has received a radio signal which specifies an identification of the radio identification arrangement has been emitted by a radio identification device and has a second form if the radio identification arrangement has received a first indication signal from another radio identification arrangement.

10. The radio identification arrangement of claim 9, wherein the second indication signal is a visual signal and the first form is visually distinguishable from the second form.

11. The radio identification arrangement of claim 1, further comprising a detector configured to detect whether the radio identification arrangement has received the first indication signal from the other radio identification arrangement.

12. The radio identification arrangement of claim 11, wherein the first indication signal is a light signal and the receiver is a photosensitive element configured to detect the first indication signal.

13. The radio identification arrangement of claim 1, comprising an RFID tag having the identification of the radio identification arrangement.

14. A physical object comprising the radio identification arrangement of claim 1, comprising a first side and a second side, wherein the signal emitter is arranged at the front side and a detector configured to detect whether the other radio identification arrangement has emitted the first indication signal is arranged at the back side.

15. The physical object of claim 14, wherein the first side is a front side and the second side is a back side opposite to the front side.

16. The physical object of claim 14, wherein the first side and the second side are adjacent sides.

17. A method for indicating the position of a physical object comprising:
a radio identification arrangement detecting whether it has received a radio signal which specifies an identification of the radio identification arrangement from a radio identification device or the radio identification arrangement has received a first indication signal from another radio identification arrangement; and
controlling a signal emitter of the radio identification arrangement to emit a second indication signal if the radio identification arrangement has received a radio signal specifying the identification from a radio identification device or the radio identification arrangement has received a first indication signal from another radio identification arrangement.
